(19) United States
(12) Patent Application Publication
(10) Pub. No.: US 2011/0281517 A1
(43) Pub. Date: Nov. 17, 2011

(54) SYSTEMS AND METHODS FOR EXECUTING A SOURCE HANDOFF FOR MEDIA CONTENT PRESENTED ON A USER DEVICE FROM A NETWORK OF SET-TOP CELLS

(75) Inventor: Sreeharsha Babu K. Ukkadam, Valencia, CA (US)

(73) Assignee: Rovi Technologies Corporation, Santa Clara, CA (US)

(21) Appl. No.: 12/780,486

(22) Filed: May 14, 2010

(51) Int. Cl. H04H 40/00

(52) U.S. Cl. 455/3.06

(57) ABSTRACT

Systems and methods for streaming media content on a user device from a wireless network of set-top cells. Set-top cells with overlapping wireless transmission ranges create a network within which a user may roam and receive continuous streaming media content. A user device may connect with a set-top cell in the network to access media content. When the user leaves the wireless transmission range of the set-top cell, a seamless handoff occurs to a second set-top cell, and the user receives continuous streaming media content. The streaming media content is uninterrupted as long as the user remains within wireless transmission range of at least one set-top cell in the network.

### BACKGROUND OF THE INVENTION

This invention relates generally to streaming media content on a user device, and more particularly, to streaming media content on a user device from a wireless network of set-top cells.

Conventional digital television systems rely on the use of a set-top box connected to the television. The set-top box receives and decodes signals to extract media content that is then provided over a wired connection to the television. Typically, in a home with multiple television sets, a set-top box is connected to each television. The need for a wired incoming cable connection and a set-top box wired to the television often limits the number of locations within a home that a television can be located.

With the advent of the Internet, mobile computing, and high-speed wireless networks, users are now accessing media on personal computers (PCs) and other devices on which they traditionally did not, such as hand-held computers, personal digital assistants (PDAs), mobile telephones, smartphones, or other user devices. Wireless devices with large computing capacity are becoming smaller, lighter, and more mobile. To support use of these devices, wireless Internet and cellular networks have been expanded and upgraded to provide faster data rates and more reliable performance to users.

As mobile devices become more powerful, media content is increasingly available to mobile users over Internet and cellular connections. Websites and services with collections of audio and video files provide streaming media content to users. For example, a television network may have a website that contains a cache of full episodes from its series that can be accessed by any user with a mobile device connected to an Internet or 3G cellular network.

With the advancements in mobile technology and the availability of media to a mobile user, there exists a need to provide users with direct access to in-home media content sources. Accordingly, it would be desirable to provide a network of wireless media sources that allows users to roam and maintain a connection to access media content directly from the media sources in the network.

### SUMMARY OF THE INVENTION

In view of the foregoing, systems and methods for streaming media content on a user device from a network of set-top cells are provided. A set-top cell may be any device having the capability to receive a media content feed and broadcast the media content over a wireless transmission range. The media content broadcast from the set-top cell may be received and presented at a user device within the wireless transmission range of the set-top cell.

When the wireless transmission ranges of multiple set-top cells overlap, a network may be created within which a user may roam and receive continuous streaming media content. A roaming user may be able to receive media content as long as he or she remains within wireless transmission range of at least one set-top cell in the network. When the user leaves the wireless transmission range of a set-top cell, a seamless handoff may occur to a second set-top cell within range of the user, and the streaming media content may be uninterrupted.

In some embodiments, a user may register a user device with a cable provider supporting a set-top cell network to gain access to the network. A registered user device may be authorized to access all set-top cells in the network, and authorization information for the user device may be stored at the cable provider headend. The set-top cells of the network may access the authorization information to perform verification before allowing a user device to access and stream media content.

In some embodiments, a user may have a media account that determines the set of media content that the user is authorized to access. When the user registers a user device, the user device may be associated with the media account of the user. The user device may then roam in the set-top cell network and connect to a set-top cell associated with a media account of any other user and still access the set of media content available through the media account with which the user device is associated.

In some embodiments, all set-top cells in a network may be supported by a single cable provider, and any user device may be registered with the cable provider in order to access the set-top cells in the network. In some embodiments, the set-top cells in a network may be supported by any number of cable providers that share authorized device information, and a user device may be registered with any one of the number of cable providers in order to access the set-top cells in the network.

Further features of the invention, its nature, and various advantages will be more apparent from the accompanying drawings and the following detailed description of the preferred embodiments.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an illustrative set-top cell in accordance with an embodiment of the present invention;

FIG. 2 shows an illustrative user device in accordance with an embodiment of the present invention;

FIG. 3 shows an illustrative cable network for presenting media content on a user device in accordance with an embodiment of the present invention;

FIG. 4 shows an illustrative display screen that may be used to register a user device with a set-top cell in accordance with an embodiment of the present invention;

FIG. 5 shows an illustrative display screen that may be used to display the authorization profile of a user device in accordance with an embodiment of the present invention;

FIG. 6 shows an illustrative network for allowing a user device registered with one cable provider to access a set-top cell supported by a second cable provider in accordance with an embodiment of the present invention;

FIG. 7 shows an illustrative network for providing an authorized device database shared by multiple cable providers in accordance with an embodiment of the present invention;

FIG. 8A shows an illustrative set-top cell network for presenting media content on a user device in accordance with an embodiment of the present invention;

FIG. 8B shows an illustrative set-top cell network for detecting the need for source handoffs in accordance with an embodiment of the present invention;

FIGS. 9A and 9B show an illustrative network for dynamically adjusting the media content available from a set-top cell in accordance with an embodiment of the present invention;

FIG. 10 shows an illustrative display screen that may be used to present a user with the option to choose to request a connection from one of multiple set-top cells within range of a user device in accordance with an embodiment of the present invention;

FIG. 11 is a flow chart of illustrative steps involved in registering a user device with a set-top cell in accordance with an embodiment of the present invention;

FIG. 12 is a flow chart of illustrative steps involved in verifying the authorization of a user device within range of a set-top cell in accordance with an embodiment of the present invention;

FIG. 13 is a flow chart of illustrative steps involved in accessing a set-top cell network from a user device that is within range of multiple set-top cells in accordance with an embodiment of the present invention; and

FIG. 14 is a flow chart of illustrative steps involved in performing a source handoff from one set-top cell to another set-top cell in accordance with an embodiment of the present invention.

### DETAILED DESCRIPTION OF EMBODIMENTS

The amount of media available to users in any given media delivery system may be substantial. Subscribers may have access to conventional television programming (provided via traditional broadcast, cable, satellite, Internet, or other means), as well as pay-per-view programs, on-demand programs (as in video-on-demand (VOD) systems), Internet content (e.g., streaming media, downloadable media, Webcasts, etc.), recorded programs (e.g., on a digital video recorder (DVR) system), and other types of media or video content. The term multimedia is defined herein as media and content that utilizes at least two different content forms, such as text, audio, still images, animation, video, and interactivity content forms. Multimedia content may be recorded and played, displayed or accessed by information content processing devices, such as computerized and electronic devices, but may also be part of a live performance. It should be understood that the invention embodiments that are described in relation to media or media content are also applicable to other types of content, such as video, audio and/or multimedia.

Subscribers have traditionally had access to media content from their cable provider only through a set-top box and television. With the advancements in mobile user devices and wireless technology, the present invention provides systems and methods that allow media content to be streamed wirelessly directly from a set-top cell to a personal computer (PC), hand-held computer, personal digital assistant (PDA), mobile telephone, smartphone, or any suitable user device.

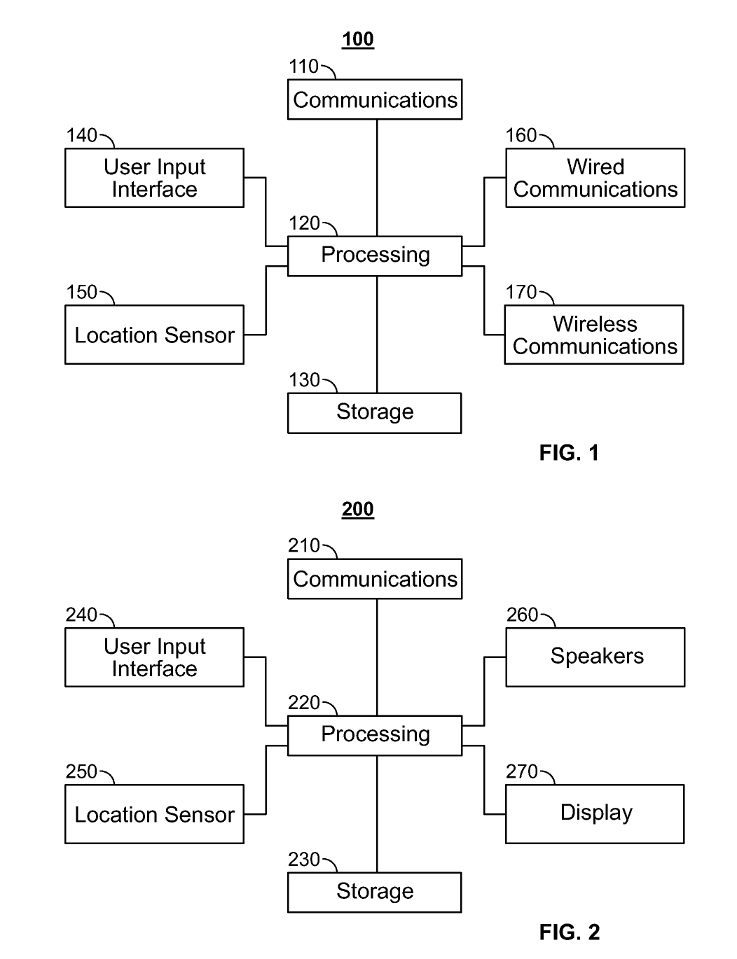

FIG. 1 shows an illustrative set-top cell 100 for streaming media content to a user device. Set-top cell 100 may be similar to a traditional set-top box that presents media content to a local television, with the added capability of also transmitting media content to wireless user devices within range. Set-top cell 100 may be an Internet Protocol TV (IPTV) set-top box that receives media content over an Internet connection and has Internet communications circuitry that is modified to broadcast the received media content using a wireless protocol. Set-top cell 100 may be a television equipped with wireless communications hardware for transmitting media content to wireless user devices within range. Set-top cell 100 may also be any other device having hardware capable of providing media content to user devices by wirelessly transmitting the media content.

Set-top cell 100 may communicate with a cable provider headend or distribution facility via communications circuitry 110. Communications circuitry 110 may include a cable modem, an integrated services digital network (ISDN) modem, a digital subscriber line (DSL) modem, a telephone modem, a wireless modem, or any other suitable circuitry for communications with other equipment. In addition, communications circuitry 110 may include circuitry that enables peer-to-peer communication or communication with other set-top cells. Communication may include receiving media content, sending and receiving requests or commands, verifying the authorization of a mobile user device, identifying nearby set-top cells, or any other suitable communication. The communications circuitry 110 may provide data and content (e.g., broadcast programming, on-demand programming, Internet content, and other audio or video) to processing circuitry 120.

Processing circuitry 120 may include one or more microprocessors, microcontrollers, digital signal processors, programmable logic devices, or any other suitable circuitry. Processing circuitry 120 may include video generating circuitry and tuning circuitry, such as one or more analog tuners, MPEG-2 decoders or other digital decoding circuitry, high-definition tuners, or any other suitable tuning or video circuitry. The tuning circuitry may include multiple tuners to handle simultaneous tuning functions (e.g., one or more tuners may be dedicated to providing media content to wired user devices and one or more tuners may be dedicated to providing media content to wireless user devices). A set-top cell that receives media content over a set frequency bandwith may include tuning circuitry that enables a user to access desired broadcast channels by tuning to a predefined frequency. Encoding circuitry may also be provided to convert over the air, analog, or digital signals either to MPEG signals for storage or to a preferred output format of a user device. Processing circuitry 120 may also include digital-to-analog converter circuitry and analog-to-digital converter circuitry for converting between digital and analog signals. Processing circuitry 120 may also include circuitry that supports IPTV technology by sending user requests for desired media content via an IP request. The IPTV circuitry then receives a video stream from a server that contains the desired media content.

Memory (e.g., random-access memory, read-only memory, or any other suitable memory), hard drives, optical drives, or any other suitable fixed or removable storage devices (e.g., digital video recorder (DVR), DVD recorder, CD recorder, video cassette recorder, or other suitable recording device) may be provided as storage 130 in set-top cell 100. Storage 130 may include one or more of the above types of storage devices. For example, set-top cell 100 may include a hard drive for a DVR (sometimes called a personal video recorder, or PVR) and a DVD recorder as a secondary storage device. Storage 130 may be used to store media content, such as programming designated for recording by a user. Storage 130 may also be used to store user information, such as a list of users with user profiles, preferences, or settings information. Storage 130 may also be used to store information about user devices that are registered and authorized with set-top cell 100. Storage 130 may also be used to store information about other set-top cells, such as locations of the set-top cells nearest to set-top cell 100. Storage 130 may also include nonvolatile memory that may be used to launch a boot-up routine or any other suitable instructions.

A user may control functions of set-top cell 100 using user input interface 140. User input interface 140 may be any suitable user interface, such as a remote control, mouse, trackball, keypad, keyboard, touch screen, touch pad, stylus input, joystick, voice recognition interface, any other suitable user input interface, or a combination of user input interfaces. User input interface 140 may be used to control the configuration and settings of set-top cell 100. User input interface 140 may also be used to navigate and manage a list of user devices that are registered with set-top cell 100, are authorized to communicate with set-top cell 100, or are currently communicating with set-top cell 100. User input interface 140 may also be used to view and manage a list of other set-top cells, for example, set-top cells nearby set-top cell 100 that may be used as recipients of source handoffs.

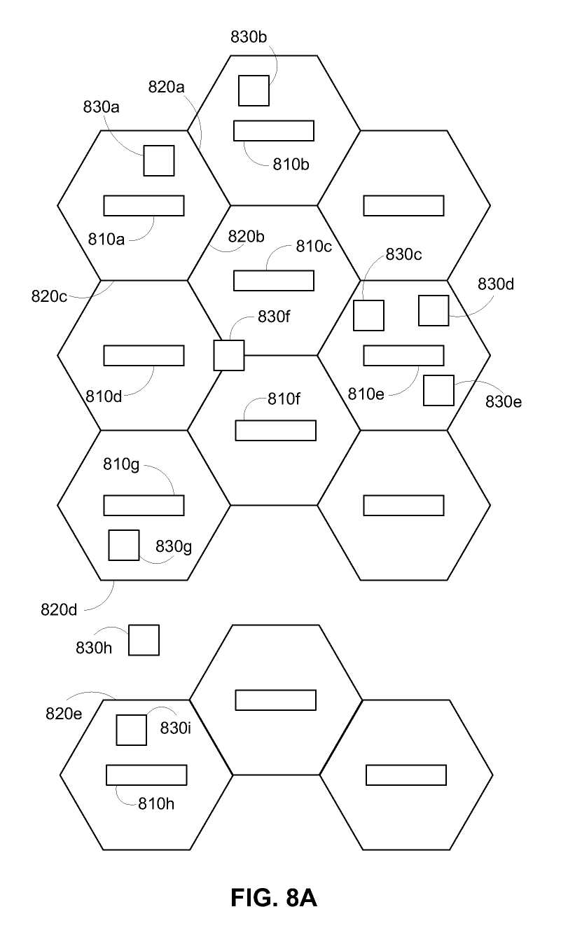

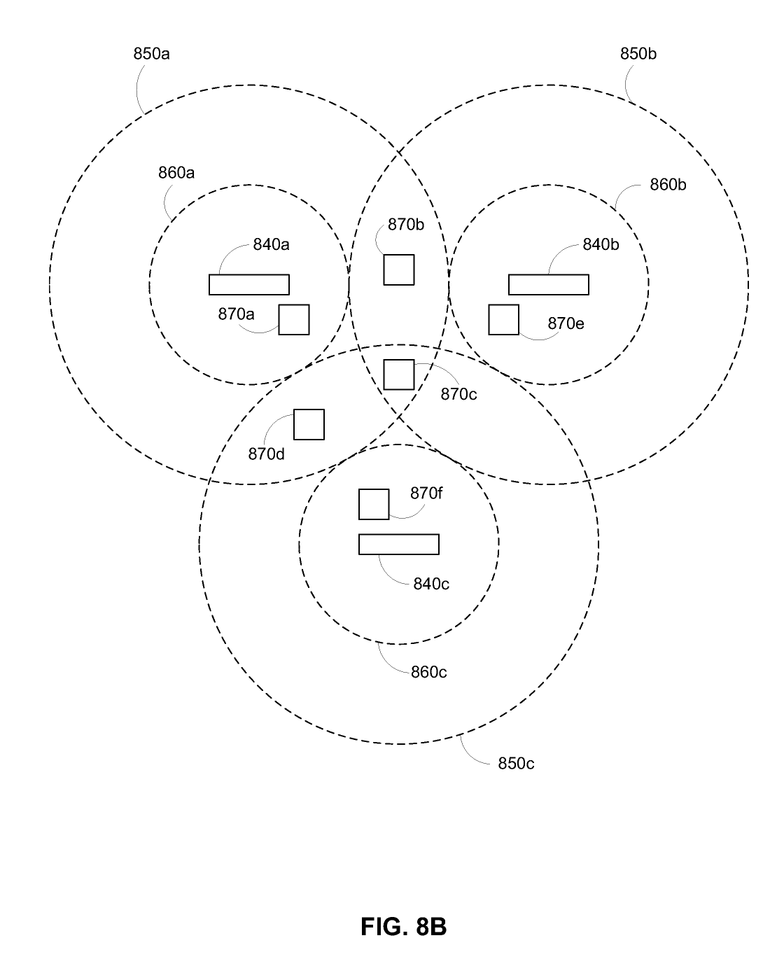

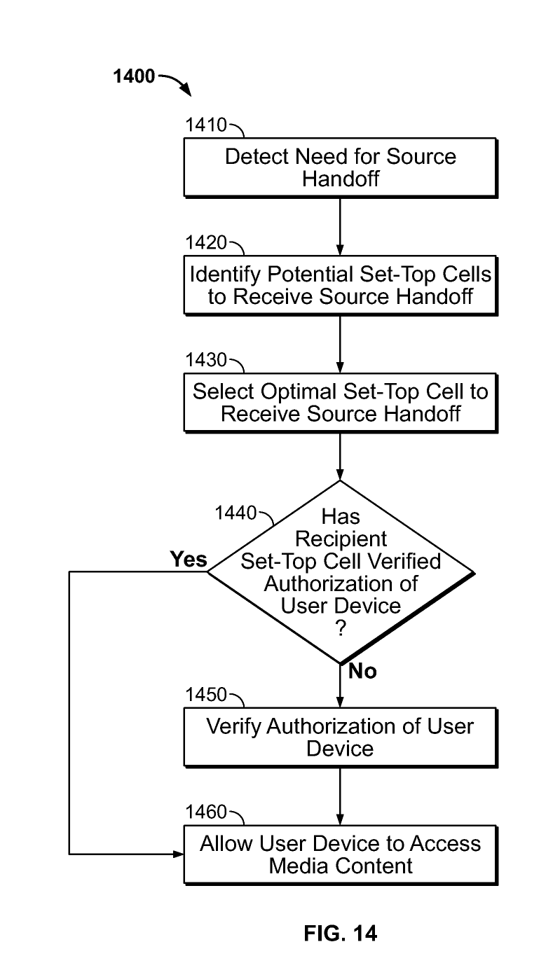

Location sensor 150 may be used to determine the location of set-top cell 100. For example, location sensor 150 may be a GPS sensor that calculates the location of set-top cell 100 based on the distances from set-top cell 100 to GPS satellites. The location obtained for set-top cell 100 may be sent and stored at a cable provider headend, on a user device, or on another set-top cell. The location information may be used during a handoff of streaming media content source. For example, a cable headend may sense the need for a source handoff from a set-top cell and may identify the best set-top cell to receive the handoff based on the locations indicated by sensors in nearby set-top cells. The source handoff process will be described in more detail in the explanations that follow with respect to FIGS. 8A, 8B, and 14.

Set-top cell 100 may communicate with local user devices via wired communications circuitry 160. Local user devices may include a television, display monitor, external DVD player, external DVR, sound system receiver, or any other suitable local user device. Wired communications circuitry 160 may support RCA, HDMI, DVI, S-Video, USB, coaxial cable, or any other suitable wired communication ports. Wired communications circuitry 160 may be used to present media content to a local user device, receive commands from a local user device, send commands to a local user device, retrieve content from a local user device, or perform any other suitable communications.

Set-top cell 100 may communicate with remote user devices via wireless communications circuitry 170. A remote user device may be any user device having wireless communication capability that is within the wireless transmission range of set-top cell 100. Wireless communications circuitry 170 may support wireless area networks (e.g., 802.11b, 802.11g, or 802.11a), wireless personal area networks (e.g., Bluetooth or ZigBee), wireless metropolitan area networks (e.g., WiMax), wireless wide area networks, mobile devices networks (e.g., Global System for Mobile Communications, Personal Communications Service, PCS, or Digital Advanced Mobile Phone Service), or any other suitable wireless networks. Wireless communications circuitry 170 may be used to present media content to a remote user device, receive commands from a remote user device, send commands to a remote user device, receive registration information from a remote user device, verify the authorization of a remote user device, execute a handoff of the source of media content streaming to a user device, or perform any other suitable communications.

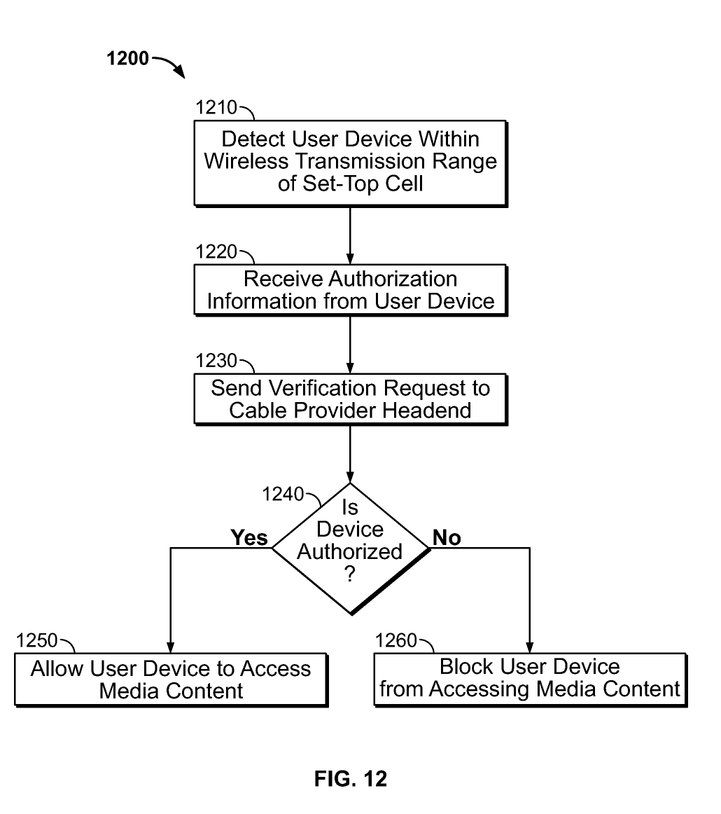

Wireless communications circuitry 170 may alert processing circuitry 120 when a user device is detected within the wireless transmission range of set-top cell 100. The processing circuitry 120 may request authorization information from the user device. When authorization information is received, processing circuitry may send the information through communications circuitry 110 for verification, for example, at a cable provider headend. Once confirmation that the user device is authorized is received by processing circuitry 120, presentation of media content to the user device may begin. A user may then view live broadcasts streamed wirelessly from set-top cell 100, media content recorded to DVR memory in storage 130 of set-top cell 100, on-demand programming, pay-per-view programming, Internet media content, or any other suitable form of media content. The authorization verification process will be described in more detail in the explanations that follow with respect to FIGS. 8A and 12.

FIG. 2 shows an illustrative user device 200 for receiving and presenting media content from a set-top cell, such as set-top cell 100 of FIG. 1. User device 200 may be a personal computer (PC), laptop computer, hand-held computer, personal digital assistant (PDA), mobile telephone, smartphone, or any other suitable user device. User device 200 may establish a wireless connection with a set-top cell to provide a user with access to all media content available from a cable provider.

User device 200 may communicate with a set-top cell via communications circuitry 210. Communications circuitry 210 may detect and establish a connection with a set-top cell within wireless transmission range of user device 200. Once a connection is established, communications circuitry 210 may send authorization information for user device 200 for verification by the set-top cell. Once authorization is verified, full communication may begin between the set-top cell and user device 200. Full communication may include receiving media content to present, accessing media guidance information, sending or receiving requests and commands, or any other suitable communication. The communications circuitry 210 may provide data and content (e.g., broadcast programming, on-demand programming, Internet content, and other audio or video) to processing circuitry 220.

Processing circuitry 220 may include one or more microprocessors, microcontrollers, digital signal processors, programmable logic devices, or other suitable circuitry. Processing circuitry 220 may receive media content from a set-top cell through communications circuitry 210 and may process the media content for presentation on user device 200. For example, the processing circuitry 220 may extract an audio component from an incoming signal to be presented by speakers 260 and may extract a video component from an incoming signal to be presented by display 270. Processing circuitry 220 may also send commands and requests to a set-top cell. Commands sent to a set-top cell may include changing the channel received by a tuner, changing the media source (e.g., live programming, on-demand content, recorded content, etc.) sent to user device 200, scheduling programming for recording to storage on the set-top cell, or any other suitable command.

Memory (e.g., random-access memory, read-only memory, or any other suitable memory), hard drives, optical drives, or any other suitable fixed or removable storage devices may be provided as storage 230 in user device 200. Storage 230 may be used to store authorization information, such as a footprint profile containing all relevant identification information for user device 200, identification information for the set-top cell with which user device 200 is registered, user profile information, any other suitable information, or any suitable combination thereof. A footprint profile may be retrieved from storage 230 and provided to a set-top cell to facilitate verification of authorization to access media content. Storage 230 may also include nonvolatile memory that may be used to launch a boot-up routine or any other suitable instructions.

Memory provided as storage 230 may also be used to store media content locally in RAM on user device 200 for presentation to the user. Due to copyright concerns, it may be preferable not to store any media content on user device 200. If media content must be temporarily stored locally in storage 230, processing circuitry 220 may add tags to the media content to satisfy concerns of content providers. For example, the stored content may be stored with a watermark or other secure identification that indicates from where the media originated, the duration of time the media was accessed, when the media was stored, or any other suitable identification information.

A user may control functions of user device 200 using user input interface 240. User input interface 240 may be any suitable user interface, such as a remote control, mouse, trackball, keypad, keyboard, touch screen, touch pad, stylus input, joystick, voice recognition interface, any other suitable user input interface, or a combination of user input interfaces. User input interface 240 may be used to control the configuration and settings of user device 200. User input interface 240 may also be used to control media content presented on user device 200, navigate and manage a list of set-top cells within range of user device 200, enter registration and authorization information for user device 200, or perform any other suitable task.

Location sensor 250 may be used to determine the location of user device 200. Location sensor 250 may have substantially the same functionality as that described with respect to location sensor 150 of FIG. 1. The location obtained from location sensor 250 may be sent to a nearby set-top cell and used during a handoff of streaming media content source. For example, if user device 200 is traveling towards the edge of the wireless transmission range of the set-top cell from which it is receiving media content, the location and direction of travel of user device 200 may be used to select a set-top cell to receive a source handoff. The set-top cell from which user device 200 is receiving media content may then initiate a source handoff to the selected set-top cell. In addition, if the set-top cell senses that no other set-top cells are located in the direction of travel of user device 200, user device 200 may present a warning to the user that the streaming media content connection is at risk of being interrupted.

User device 200 may present media content to a user over speakers 260 and display 270. Speakers 260 and display 270 may also be used to assist the user in navigating media content by presenting visual and audio warnings to the user, providing a media guidance application to the user, assisting the user in selection of media content source, or any other suitable media navigation. Display 270 may also assist the user in registering user device 200 with a set-top cell, selecting from set-top cells within range of user device 200, or providing information from the authorization footprint profile of user device 200.

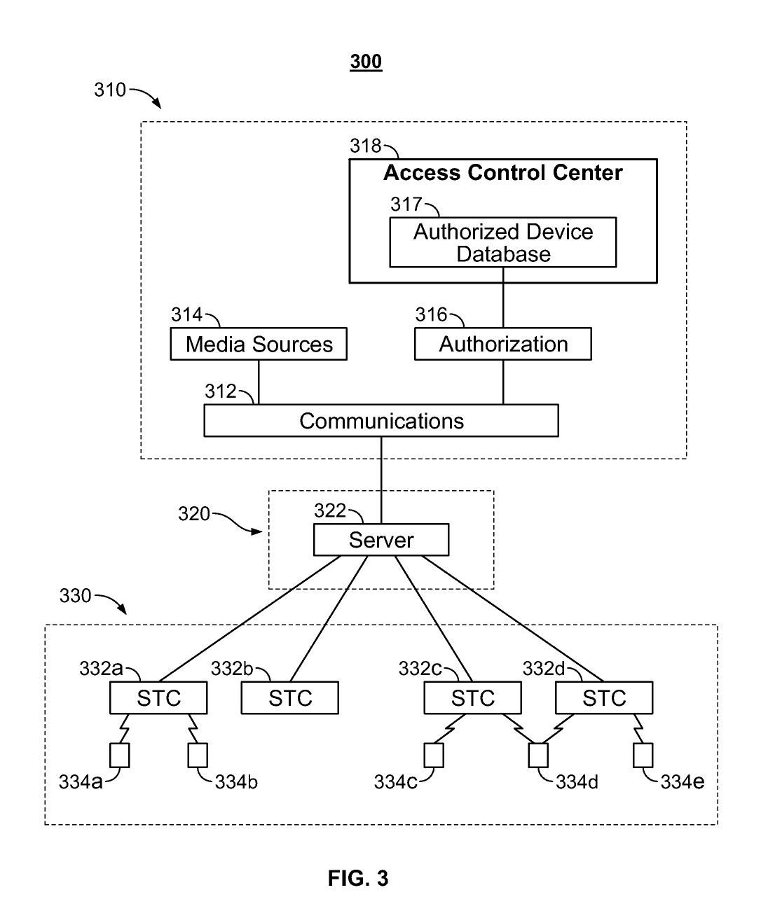

An illustrative example of the distribution of media content to user devices in a set-top cell network is shown in the cable network 300 of FIG. 3. Media content is transmitted from cable provider headend 310 to set-top cell network 330 via distribution facility 320. The cable provider headend 310 includes communications 312, media content sources 314, authorization 316, and an access control center 318 which contains an authorized device database 317. The distribution facility 320 includes a server 322 for directing media content to set-top cells in set-top cell network 330. The set-top cell network 330 includes set-top cells 332a, 332b, 332c, and 332d. User devices 334a, 334b, 334c, 334d, and 334e may establish connections with the set-top cells of the network. When a connection is established with a set-top cell, an authorized user device in set-top cell network 330 can access, control, receive, and present media content from cable headend 310.

The interaction of a user device with the set-top cells of a network begins with initial registration of the user device. Registration of a user device may be performed through a user's “home” set-top cell. For example, a user may subscribe to a cable service and have a set-top cell installed in his or her home. The home set-top cell will receive and provide the user with all media content that he or she is authorized to access based on the cable subscription. The user may be associated with a media account that dictates the media available through the set-top cell based on a purchased cable package or additional fees that the user has paid. All user devices that the user wishes to use to access the set-top cell network must first be registered through the user's installed home set-top cell and may also be associated with the user's media account.

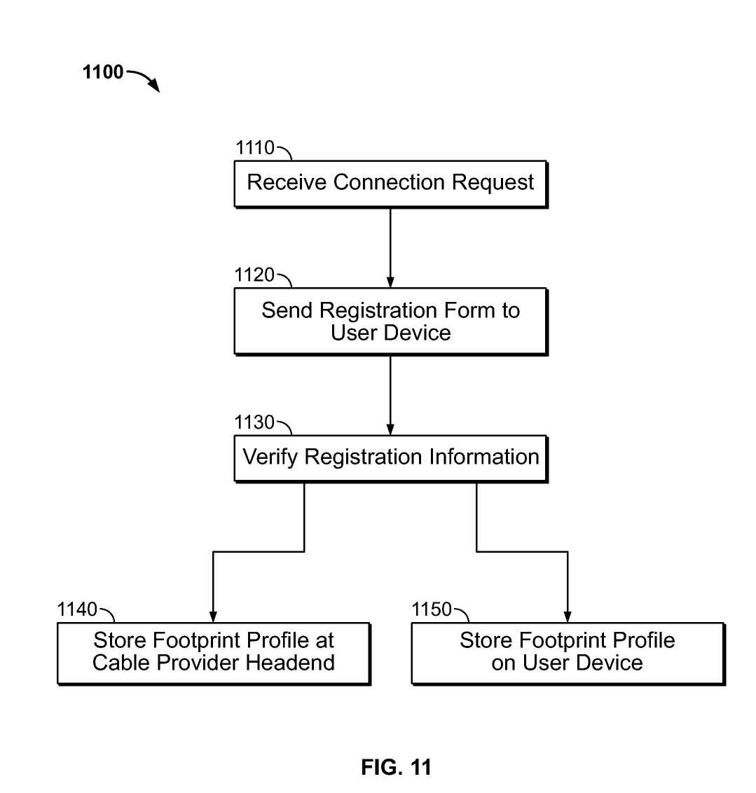

To register a user device, the user places the user device within the wireless transmission range of the home set-top cell, and a connection request initiates communication between the user device and the set-top cell. For example, a user whose home set-top cell is set-top cell 332a may place his or her user device 334a within the wireless transmission range of set-top cell 332a. In some embodiments, sending a connection request may be performed using user device 334a. In some embodiments, sending a connection request may be performed using set-top cell 332a. The connection request and initiation processes will be described in more detail in the explanations that follow with respect to FIGS. 8A and 11. After a connection is initiated, set-top cell 332a then sends a form to user device 334a requesting registration information.

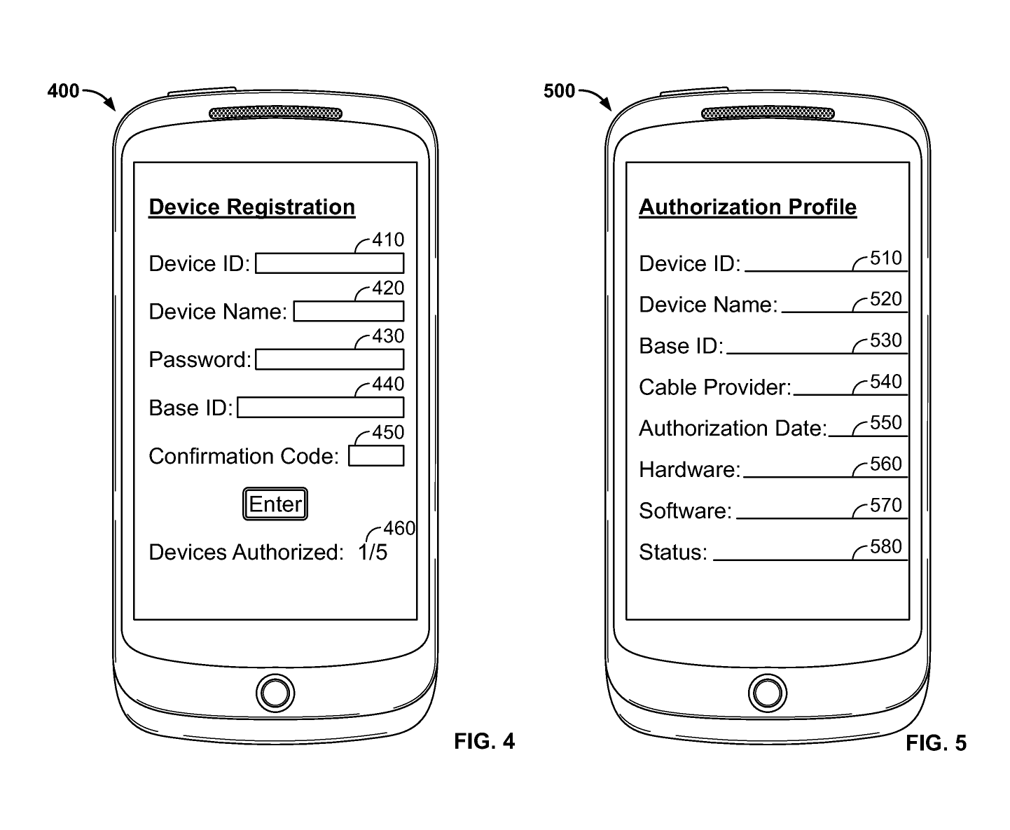

Registration information that may be requested by set-top cell 332a is shown in the illustrative display screen of FIG. 4. Display screen 400 may be a display of any suitable device, but is described herein as a display of a registration form sent to user device 334a from set-top cell 332a. The registration form contains fields for device ID 410, device name 420, password 430, base ID 440, confirmation code 450, and devices authorized indicator 460.

The device ID entered into device ID field 410 may be a unique identifier for user device 334a, such as a model number, serial number, model name, device manufacturer, or any other suitable identifier. The device ID may be used to verify that user device 334a is compatible with set-top cell network 330. The device ID may also be used by the cable provider to obtain data indicating the types of user devices being used within set-top cell network 330. The data obtained may be used by the cable provider to optimize the performance of set-top cell network 330.

The device name entered into device name field 420 may be an identifier provided by the user for user device 334a. The user may provide a device name that is more easily recognizable than the device ID, such as “Bedroom TV” or “Dad's Smartphone”. Providing easily recognized names for each user device allows a user to view and manage a list of devices authorized with his or her home set-top cell without having to match complex serial or model numbers to individual user devices.

The password entered into password field 430 may be set by the user and may be required as a security check each time a connection is initiated between user device 334a and set-top cell network 330. The password may be different for each user device registered with a single set-top cell, or may be the same for all user devices registered to the same set-top cell. Requiring a password each time a connection is established between user device 334a and the set-top cell network 330 could prevent unauthorized users from gaining access to the set-top cell network 330 if, for example, user device 334a is lost or stolen.

The base ID entered into base ID field 440 may be a unique identifier for the home set-top cell 332a with which user device 334a is being registered, such as a model number, serial number, model name, device manufacturer, or any other suitable identifier. The confirmation code entered into confirmation code field 450 may be provided by the cable provider. The device ID, base ID, and confirmation code may be used by the cable provider to verify that a user is registering user device 334a with the correct home set-top cell 332a. For example, a unique confirmation code may be associated with a unique device ID or base ID and may be provided to a cable subscriber only if he or she pays an extra fee for access to the set-top cell network.

The devices authorized indicator 460 may be included on the registration form if there is a limit to the number of user devices that a user is authorized to register with his or her home set-top cell. The devices authorized indicator 460 may be used to inform the user whether or not he or she has unused device authorizations remaining. The cable provider may charge a fee for every user device that is authorized with a home set-top cell, and the devices authorized indicator may indicate the number of devices currently authorized and the total number of user devices the user may authorize based on the fees he or she has paid. The total number of allowed authorizations may also indicate a limit on registered devices for each user implemented by the cable provider in order to limit the demand placed on the set-top cell network. As long as the number of devices currently authorized is less than the total number of allowed authorizations, the user has unused device authorizations remaining.

Registration information entered by the user into user device 334a is sent to set-top cell 332a and on to the cable provider headend 310 via distribution facility 320. At cable provider headend 310, the registration information is received and sent to authorization 316 and access control center 318. Authorization 316 analyzes the registration information to ensure that the information is valid. Authorization 316 may verify that the device ID indicates a compatible device, that the selected device name does not match a device name already registered on set-top cell 332a, that the device ID, base ID, or confirmation code match the records maintained by the cable provider, that the user has unused device authorizations remaining, or may perform any other suitable verification check. Authorization 316 may access a media account associated with the user to validate that any registration information matches information in the media account.

After validation and acceptance of the registration information, the access control center 318 creates a footprint profile of the relevant authorization information for user device 334a and stores the footprint profile locally in authorized device database 317 for future authorization verification by other set-top cells of set-top cell network 330, such as set-top cells 332b, 332c, and 332d. Cable provider headend 310 also sends the footprint profile to user device 334a to be stored locally. When set-top cells in the set-top cell network 330 request authorization verification, user device 334A may retrieve and send the locally stored footprint profile to be compared to the footprint profile stored in authorized device database 317.

Information that may be contained in the footprint profile for a user device is shown in the illustrative display screen of FIG. 5. Display screen 500 may be a display of any suitable device, but is described herein as a display of an authorization footprint profile on user device 332a. Display screen 500 includes a device ID field 510, device name field 520, and base ID field 530 that may correspond to device ID field 410, device name field 420, and base ID field 440, provided by the user during registration and discussed in the foregoing explanation of the illustrative display screen of FIG. 4. The footprint profile may also contain a cable provider field 540 that indicates the cable provider with which the user device is registered, an authorization date field 550 that indicates the date on which the user device was first registered with a home set-top cell, a hardware field 560 and software field 570 that indicate the types or versions of hardware and software on the user device, and a status field 580 that indicates the authorization status of the user device. Status field 580 may contain, for example, an indication of whether or not the user device is currently authorized to receive media content from the set-top cell network based on the status of bill payments to the cable provider, holds placed on the user's account, blocks placed on users no longer subscribed with the cable provider, or any other suitable authorization status.

A subscriber with a user device that has been registered with the subscriber's home set-top cell and authorized to receive media content from set-top cell network 330 may begin streaming media content from any set-top cell in set-top cell network 330. The media content originates from media content sources 314 in cable provider headend 310. Communications 312 in cable provider headend 310 handles two-way communication with the distribution facility 320 to provide end users in the set-top cell network 330 with any media content from media content sources 314 that they are authorized to access.

The media content that a user is authorized to access on a user device may be dictated by a media account for the user. For example, a user may subscribe to a cable service and pay extra fees for access to premium channels, program recordings (e.g., DVR), or on-demand content. The user's media account contains a record of all content for which the user has paid and is allowed to access. When a first user roams through set-top cell network 330, he or she may access the network on a user device by connecting to a set-top cell that is associated with a media account for second user. Once authorization of the user device is verified by the set-top cell, the set-top cell will provide the first user with all media content that the first user is authorized to access based on the media account for the first user. At the same time, the set-top cell will allow the second user to access all media content that the second user is authorized to access based on the media account for the second user. For example, the set-top cell may provide the first user with media content from a premium channel for which the first user has paid an additional fee and, at the same time, block the second user from accessing the premium channel if he or she has not paid the additional fee. The set-top cell network thus provides users with all media content that they are authorized to view based on their media account regardless of the media accounts associated with the set-top cells to which they are connected.

The embodiment shown in FIG. 3 is a cable network supported by a single cable provider. A user device may be easily authorized by any of the set-top cells in set-top cell network 330 because all of the set top cells are linked to a common access control center 318 and can access a common authorized device database 317 to verify authorization of a user device. A user device registered with set-top cell network 330 may have a need to connect to a set-top cell network that is supported by a second cable provider. For example, when a user travels to a town that has a different predominant cable provider than the user's hometown, the user may want to connect to the set-top cells in the town. Thus, a system is provided for user devices registered with one cable provider to access set-top cells supported by a second cable provider.

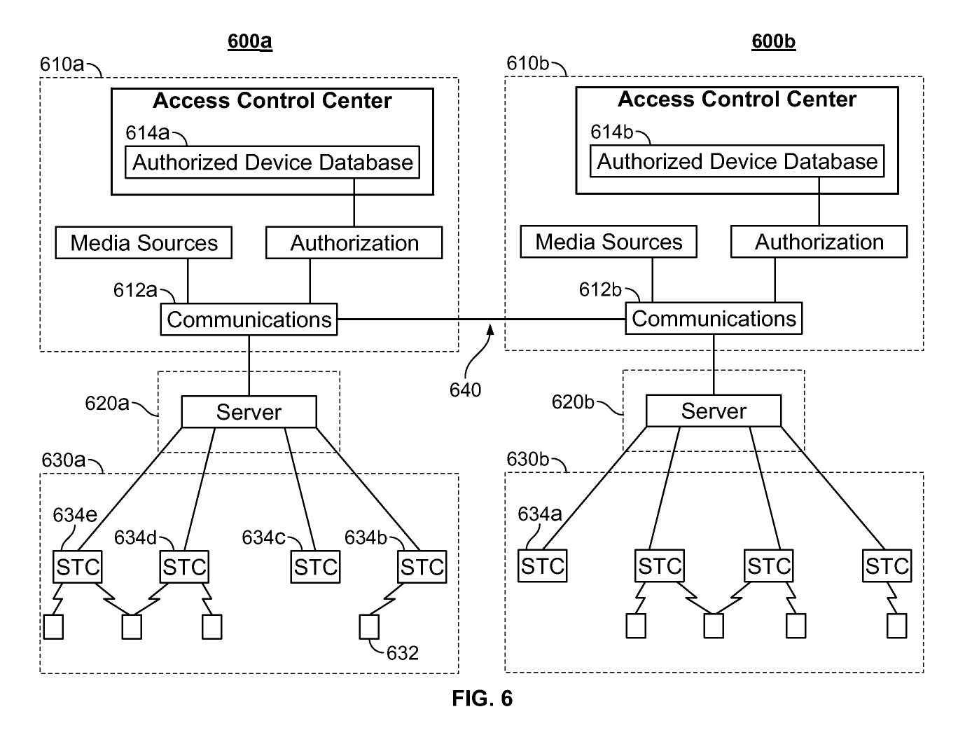

FIG. 6 shows a network that allows user devices registered with one cable provider to access set-top cells supported by a second cable provider. A cable network 600a supported by cable provider X includes of cable provider X headend 610a, distribution facility 620a, and set-top cell network 630a. A cable network 600b supported by cable provider Y includes of cable provider Y headend 610b, distribution facility 620b, and set-top cell network 630b. Either one of cable network 600a and cable network 600b may correspond to cable network 300 of FIG. 3. In addition to the features described in the foregoing discussion of cable network 300, cable networks 600a and 600b include a communication link 640 that connects the communications 612a of cable provider X headend 610a to the communications 612b of cable provider Y headend 610b.

Communication link 640 allows cable providers X and Y to share authorized device databases. For example, authorized device database 614a in cable provider X headend 610a is accessible to cable provider Y headend 610a via communication link 640 and communications 612a. Additionally, authorized device database 614b in cable provider Y headend 610b is accessible to cable provider X headend 610a via communication link 640 and communications 612b. For security and privacy concerns, the access allowed over communication link 640 may be limited. For example, cable provider X headend 610a may be able to access a read-only copy of authorized device database 614b in cable provider Y headend 610b. This prevents cable provider X from making any changes to the authorized device database 614b that are not approved by cable provider Y.

The sharing of authorized device databases allows users registered with one cable provider to access media content over a connection with a set-top cell supported by a second cable provider. For example, user device 632 is registered with cable provider Y headend 610b, and set-top cell 634a is the home set-top cell for user device 632. During registration, a footprint profile indicating that user device 632 is registered with cable provider Y is stored in authorized device database 614b at cable provider Y headend 610b. A copy of the footprint profile is also stored locally on user device 632. User device 632 may then enter the wireless transmission range of set-top cell 634b and request a connection to stream media content. Set-top cell 634b receives authorization information, such as the footprint profile, from user device 632 and forwards the information to cable provider X headend 610a for verification. Communications 612a recognizes that the footprint profile indicates that user device 632 is registered with a different cable provider (e.g., cable provider Y) and forwards the footprint profile over communication link 640 for verification at cable provider Y headend 610b. The footprint profile provided by user device 632 is matched with the footprint profile stored in authorized device database 614b, and communications 612b sends a positive authorization verification over communication link 640 to cable provider X headend 610a. The verification is forwarded to set-top cell 634b, and user device 632 is granted access to stream media content from set-top cell 634b. The user may roam among set-top cell network 630a, and each of set-top cells 634c, 634d, and 634e may perform similar authorization verification for user device 632.

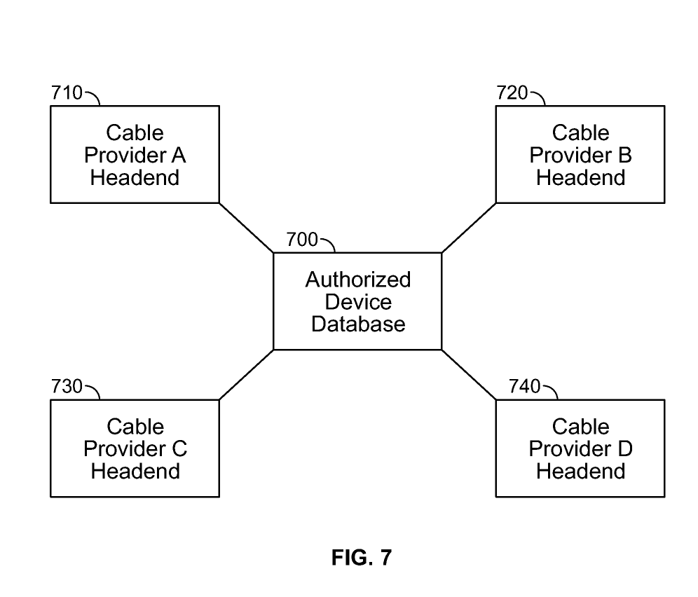

FIG. 6 shows an embodiment with two cable providers sharing access to authorized device databases, but any number of cable providers may share network access. All cable providers sharing access may have a communication link (e.g., communication link 640) to the headends and authorized device databases of all other cable providers with which access is shared. In an alternative embodiment shown in FIG. 7, there may be a single authorized device database maintained on a server to which multiple cable providers have direct access. Authorized device database 700 contains information for all devices registered with cable providers A, B, C, and D. Each of cable provider A headend 710, cable provider B headend 720, cable provider C headend 730, and cable provider D headend 740 may directly access authorized device database 700. This allows each cable provider to add, delete, or modify device profiles in authorized device database 700 without having to communicate with the headends of other cable providers. In either embodiment, a user device registered with a first cable provider is able to access media content from a set-top cell supported by a second cable provider as long as authorized device information from the first cable provider is accessible to the second cable provider.

When multiple set-top cells are located in close proximity to each other, their wireless transmission ranges may overlap. The overlapping wireless transmission ranges create a network in which a user may roam freely and receive uninterrupted streaming media content on a user device. While roaming within the network, a user may leave the range of a first set-top cell and enter the range of a second set-top cell. A seamless source handoff occurs from the first set-top cell to the second set-top cell to allow the user to experience continuous media content streaming. The user may continue viewing media content as long as he or she is within range of at least one set-top cell in the network. When the user is not in range of any set-top cells, streaming media content is unavailable until the user reenters the range of at least one set-top cell. The source handoff process will be described in more detail in the explanations with respect to FIGS. 8A, 8B, and 14 that follow.

An illustrative set-top cell network is shown in FIG. 8A. Network 800a includes set-top cells having overlapping wireless transmission ranges. Each region in network 800a contains a set-top cell. Each set-top cell in network 800a has a wireless transmission range that overlaps at least with the wireless transmission ranges of neighboring set-top cells. For example, the wireless transmission range of set-top cell 810a overlaps with the wireless transmission ranges of set-top cells 810b, 810c, and 810d. The boundaries shown between the set-top cells of the network are merely illustrative and do not indicate the limits of wireless transmission ranges. For example, the wireless transmission range of set-top cell 810a may extend beyond boundaries 820a, 820b, and 820c. The set-top cells of network 800a may all be supported by a single cable provider or, alternatively, may be supported by any number of cable providers that share authorized user device information.

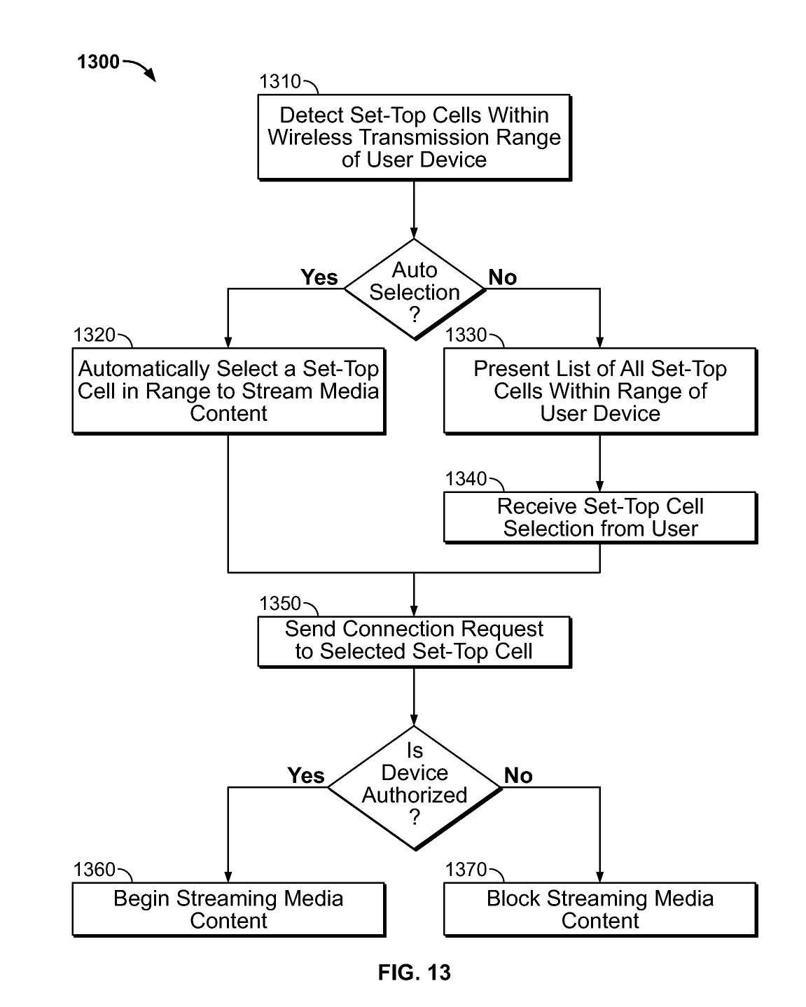

The set-top cells that make up network 800a may each obtain and store in local memory information about nearby set-top cells. This information may include a base ID, location, hardware information, or any other suitable identifying information. Using this information, the set-top cells of network 800a may facilitate presentation of media content to a user device without interrupting the media content streamed by the user device. For example, a set-top cell may use information about nearby set-top cells to facilitate selection of a set-top cell source to stream media content to a user device that is within range of multiple set-top cells or to facilitate selection of a recipient set-top cell for a seamless source handoff. The use of information associated with nearby set-top cells to perform these processes will be described in more detail in the explanations that follow with respect to FIGS. 13 and 14.

An authorized user device within the wireless transmission range of at least one of the set-top cells of network 800a may receive and present streaming media content. For example, authorized user device 830a may establish a connection and receive media content from nearby set-top cell 810a. If user device 830a crosses boundary 820a and, in doing so, leaves the wireless transmission range of set-top cell 810a and moves to the location of user device 830b, a seamless handoff occurs. During the handoff, a connection is established between user device 830b and set-top cell 810b. More than one user device may receive media content from a single set-top cell at one time. For example, user devices 830c, 830d, and 830e may all receive media content from set-top cell 810e at the same time. A user device may be able to receive media content from multiple set-top cells at one time. For example, user device 830f may be within the wireless transmission ranges of set-top cells 810c, 810d, and 810f. A selection may be made, either automatically or based on user input, from among set-top cells 810c, 810d, and 810f to provide media content to user device 830f. A user device that leaves the range of all set-top cells within the set-top cell network is unable to stream media content until the user device reenters the range of a set-top cell in the network. For example, user device 830h, which is not within the wireless transmission range of any set-top cells in network 800a, is unable to stream media content. If user device 830h enters the wireless transmission range of any of the set-top cells of network 800a, a connection may be established with the set-top cell in range and media streaming may begin. These and other processes and features of network 800a will be explained in more detail in the figures and descriptions that follow.

An illustrative example of user device registration is described with respect to user device 830a. A cable subscriber may register user device 830a with home set-top cell 810a. Following registration, user device 830a is authorized to receive and stream media content from any set-top cell in network 800a. User device 830a may begin streaming media content from set-top cell 810a. Media content continues to stream to user device 830a from set-top cell 810a as long as user device 830a remains within the wireless transmission range of set-top cell 810a.

An illustrative example of media content source handoff is described with respect to user device 830a. A determination may be made that a source handoff for media content streaming to user device 830a is preferable. The determination may be made based on the locations of user device 830a and set-top cell 810a, the strength of the signal received from set-top cell 810a by user device 830a, the bandwidth availability of set-top cell 810a, the demand placed on set-top cell 810a by all user devices to which it is currently connected, or any other suitable criteria. For example, if user device 830a approaches boundary 820a and signals received by user device 830a from set-top cell 810a become weaker, a determination may be made that a source handoff from set-top cell 810a to another set-top cell is preferable. In some embodiments, set-top cell 810a may send media content to multiple user devices (not shown). When sending media content to multiple user devices, there is a demand load placed on set-top cell 810a that may increase when the number of user devices connected to set-top cell 810a increases. Set-top cell 810a may be configured to detect that the demand load caused by the user devices reaches a threshold demand level, and set-top cell 810a may determine that a source handoff is necessary for at least one of the user devices to decrease the demand load.

An identification may be made of the optimal set-top cell to be the recipient of the source handoff from set-top cell 810a. The identification may be made by set-top cell 810a, by user device 830a, by a cable headend such as cable provider headend 310 of FIG. 3, or by any other suitable device. The identification may be made based on information stored locally or obtained by set-top cell 810a or user device 830a about other set top cells in the vicinity of user device 830a. The information stored or obtained may include the locations of set-top cells neighboring set-top cell 810a, the strength of signals received from other set-top cells at user device 830a, the bandwidth availabilities of nearby set-top cells, or any other suitable criteria for identifying a recipient set-top cell for the source handoff. For example, as user device 830a approaches boundary 820a and signals received by user device 830a from set-top cell 810 become weaker, set-top cell 810a may retrieve location information for set-top cells 810b, 810c, and 810d from memory. Set-top cell 810a may use the retrieved location information and the sensed direction of travel of user device 830a to select set-top cell 810b over set top-cells 810c and 810d as the optimal recipient of the source handoff. This selection may also be made based on the strength of signals received at user device 830a from set-top cells 810b, 810c, and 810d, the bandwidth availabilities of set-top cells 810b, 810c, and 810d, the demand placed on each of set-top cells 810b, 810c, and 810d by all user devices to which they are currently connected, or any other suitable criteria.

As user device 830a approaches boundary 820a and signals received by user device 830a from set-top cell 810 become weaker, user device 830a may enter the wireless transmission range of set-top cell 810b, causing set-top cell 810b to perform an authorization check for user device 830a. User device 830a responds to a request from set-top cell 810b by sending authorization information, such as the authorization information contained in the footprint profile shown in the illustrative display screen of FIG. 5, to set-top cell 810b. Set-top cell 810b then forwards the authorization information to a cable provider headend, such as cable provider headend 310 of FIG. 3, for comparison against a collection of footprint profiles, such as authorized device database 317 of FIG. 3. If the provided authorization information matches a footprint profile stored in the collection of footprint profiles, the cable provider sends positive verification to set-top cell 810b. Set-top cell 810b may then begin streaming media content to user device 830a.

Set-top cell 810b may complete an authorization verification for user device 830a prior to user device 830a leaving the wireless transmission range of set-top cell 810a. This allows for a seamless source handoff from set-top cell 810a to set-top cell 810B without interrupting the media content streamed on user device 830a. For example, if user device 830a is located on boundary 820a and receives signals of equal strength from set-top cells 810a and 810b, authorization verification may be completed by set-top cell 810b, and full access may be available to both set-top cells 810a and 810b. If user device 830a continues to travel to the location of user device 830b outside of the wireless transmission range of set-top cell 810a and within the wireless transmission range of set-top cell 810b, a full seamless source handoff is completed, and the user device at location 830b continues streaming media content from set-top cell 810b.

In some embodiments, each set-top cell in network 800a may be configured with a demand load threshold that is used to limit the demand placed on the set-top cell by all user devices that are connected to the set-top cell. The set-top cells in network 800a may all have the same demand load threshold or, alternatively, may have different demand load thresholds. When the demand placed on a set-top cell by connected user devices reaches the demand load threshold associated with the set-top cell, the set-top cell detects an overload. The set-top cell then initiates source handoffs for one or more of the connected user devices to balance the load demand by handing off user devices to neighboring set-top cells. The set-top cell may initiate source handoffs until the demand placed on the set-top cell drops below the demand load threshold or, alternatively, may continue to initiate source handoffs until the demand placed on the set-top cell is nearly equally to the demand placed on neighboring set-top cells.

In some embodiments, each set-top cell in network 800a may be associated with a maximum wireless transmission range and a minimum wireless transmission range that are used to detect the need for a source handoff. An illustrative example of this approach is shown in FIG. 8B. Set-top cells 840a, 840b, and 840c are associated with maximum wireless transmission ranges defined by boundaries 850a, 850b, and 850c, respectively, and minimum wireless transmission ranges defined by boundaries 860a, 860b, and 860c, respectively. User device 870a is located within the minimum wireless transmission range of set-top cell 840a and receives streaming media content from set-top cell 840a. If user device 870a moves to the location of any one of user devices 870b, 870c, or 870d, user device 870a crosses boundary 860a and enters the region between the minimum and maximum wireless transmission ranges of set-top cell 840a. By entering this region, user device 870a triggers detection of a potential need for a source handoff, and the process of identifying potential recipient set-top cells begins.

If user device 870a travels to the location of user device 870b, set-top cell 840b is identified as the lone potential recipient of a source handoff. As soon as user-device 870b crosses boundary 850b and enters the wireless transmission range of set-top cell 840b, set-top cell 840b performs authorization verification for user device 870b. User device 870b is then allowed full access to set-top cell 840b. If user device 870b continues to travel to the location of user device 870e, a full seamless source handoff is completed, and user device 870e continues streaming uninterrupted media content from set-top cell 840b. User device 870e continues streaming media content from set-top cell 840b until user device 870e crosses boundary 860b, and the need for a source handoff to a new set-top cell is again detected. Likewise, if user device 870a crosses boundary 860a and travels to the location of user device 870d, set-top cell 840c is identified as the lone potential recipient of a source handoff. Authorization verification for user device 870d is completed by set-top cell 840c, and user device 870d is allowed full access to set-top cell 840c. If user device 870d continues to travel to the location of user device 870f, a full seamless source handoff is completed, and user device 870f continues streaming uninterrupted media content from set-top cell 840c. User device 870f continues streaming media content from set-top cell 840c until user device 870f crosses boundary 860c, and the need for a source handoff to a new set-top cell is again detected.

Alternatively, user device 870a may cross boundary 860a and travel to the location of user device 870c. The need for a source handoff is detected, and the process of identifying potential recipient set-top cells begins. Since user device 870c is within the wireless transmission range of both set-top cells 840b and 840c, both set-top cells are identified as possible source handoff recipients. Authorization verification for user device 870c is completed by both set-top cell 840b and set-top cell 840c, and user device 870c is allowed full access to both set-top cell 840b and set-top cell 840c. If user device 870c travels to the location of user device 870e, a full seamless source handoff is completed, and user device 870e continues streaming uninterrupted media content from set-top cell 840b. Alternatively, if user device 870c travels to the location of user device 870f, a full seamless source handoff is completed, and user device 870f continues streaming uninterrupted media content from set-top cell 840c.

An illustrative example of streaming media content to multiple user devices from a single set-top cell is described with respect to set-top cell 810e. Multiple user devices 830c, 830d, and 830e may be within the wireless transmission range of a single set-top cell 810e. User devices 830c, 830d, and 830e are all able to receive streaming media content from set-top cell 810e simultaneously. User devices 830c, 830d, and 830e may simultaneously stream the same media content from set-top cell 810e or, alternatively, may simultaneously stream different media content from set-top cell 810e. In one approach, streaming different media content from set-top cell 810e to user devices 830c, 830d, and 830e may be accomplished by providing multiple independent tuners in set-top cell 810e. Each of user devices 830c, 830d, and 830e may access a different tuner in set-top cell 810e and, thus, may direct each tuner to provide different media content. Alternatively, streaming different media content from set-top cell 810e to user devices 830c, 830d, and 830e may be accomplished by a single tuner in set-top cell 810e.

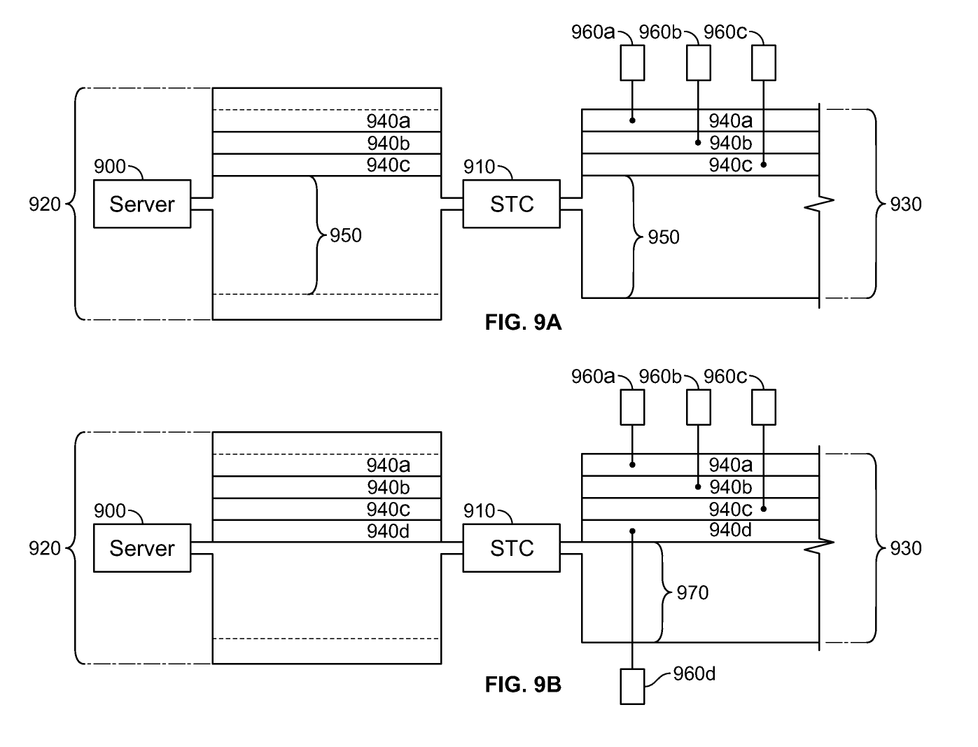

Media content may be sent to set-top cells over a range of frequencies. For example, in a standard radio frequency (RF) cable system, channels 2 through 4 are broadcast in the frequency range 54 MHz to 72 MHz, channels 5 through 6 are broadcast in the frequency range 76 MHz to 88 MHz, channels 7 through 13 are broadcast in the frequency range 174 MHZ to 216 MHz, and channels 14 through 69 are broadcast in the frequency range 470 MHz to 806 MHz. Set-top cell 810e may contain electronic circuitry or equipment that is capable of tuning to a range of frequencies to provide a range of different media content to a user. An embodiment for implementing this approach is shown in FIGS. 9A and 9B, in which server 900 may correspond to server 322 of FIG. 3, set-top cell 910 may correspond to set-top cell 810e of FIG. 8A, and user devices 960a, 960b, and 960c may correspond to user devices 830c, 830d, and 830e of FIG. 8A. In FIG. 9A, server 900 provides media content within frequency range 920 to set-top cell 910. Set-top cell 910 includes a tuner that is capable of tuning to a tunable frequency range 930 within frequency range 920 and presents all media within tunable frequency range 930 to user devices 960a, 960b, and 960c. Server 900 may dynamically adjust the channels provided within tunable frequency range 930 based on channel requests sent from user devices 960a, 960b, and 960c. For example, in the embodiment pictured, user device 960a, 960b, and 960c request channels 940a, 940b, and 940c, respectively. The server 900 adjusts the content provided within the tunable frequency 930 to include these channels. With this approach, extra bandwidth is available in vacant frequency range 950 and may be utilized if new channels are requested. For example, in FIG. 9B, a new user device 960d connects to set-top cell 910 and requests channel 940d that is different from channels 940a, 940b, and 940c. Server 900 receives the request and sends the new channel requested by the new user device at a frequency within the vacant frequency range 950. User device 960d may then stream the content provided on channel 940d. Channel 940d occupies a portion of vacant frequency range 950, and thus a smaller vacant frequency range 970 is available for handling future requests after user device 960d connects.

The user devices connected to set-top cell 910 in FIG. 9B may not be allowed to access all media content sent by set-top cell 910 if, for example, the user devices are associated with different media accounts. For example, user devices 960a, 960b, and 960c may all be registered with set-top cell 910 as their home set-top cell and may all be associated with a media account for a first user. User device 960d may be associated with a media account for a second user that is authorized to access a different set of media content than the first user. For example, the second user may pay an extra fee to access a premium channel, such as channel 940d, that the first user does not pay for and, therefore, is not authorized to access. When user device 960d requests channel 940d from set-top cell 910, set-top cell 910 will provide channel 940d to user device 960d since the media account with which user device 960d is associated indicates that the user is authorized to access channel 940d. At the same time, set-top cell 910 will not provide channel 940d to user devices 960a, 960b, and 960c since the media account with which user devices 960a, 960b, and 960c are associated indicates that the user is not authorized to access channel 940d.

An illustrative example of selecting a set-top cell for streaming media content to a user device within range of multiple set-top cells is described with respect to user device 830f. User device 830f may be within the wireless transmission range of set-top cells 810c, 810d, and 810f at one time. A selection of one of set-top cells 810c, 810d, and 810f is made to determine which set-top cell to use as a source for streaming media content to user device 830f. The selection may be made automatically by user device 830f, by set-top cells 810c, 810d, and 810f, or by a cable provider headend. The selection may be made automatically based on location information for set-top cells 810c, 810d, and 810f and user device 830f, the strength of signals received from set-top cells 810c, 810d, and 810f at user device 830f, the bandwidth availabilities of set-top cells 810c, 810d, and 810f, the demand placed on each of set-top cells 810c, 810d, and 810F by all user devices to which they are currently connected, or any other suitable criteria. Once a set-top cell is selected to be the source, media content is streamed from the selected set-top cell to user device 830f. The non-selected set-top cells may maintain communication with and monitoring of user device 830f to facilitate a seamless handoff if user device 830f travels outside of the wireless transmission range of the selected set-top cell.

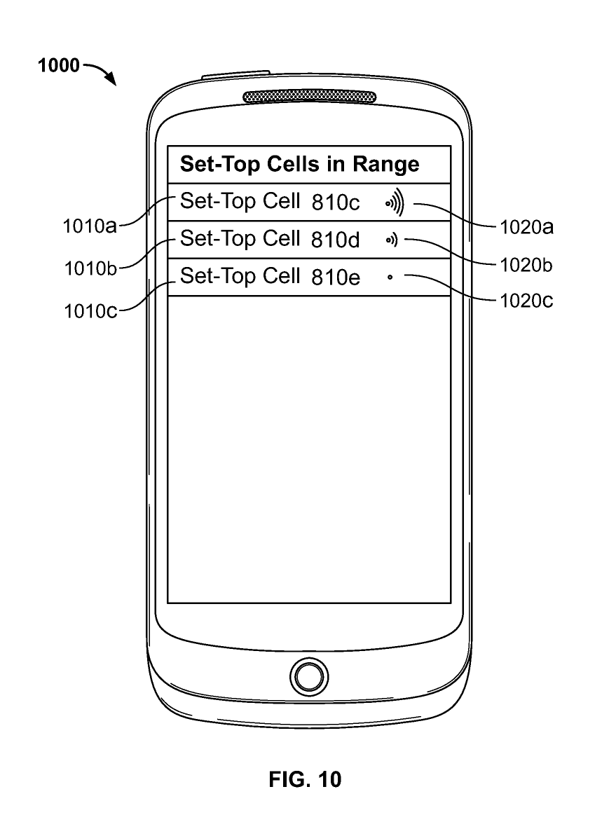

The selection of one of set-top cells 810c, 810d, and 810f to use as a source for streaming media content to user device 830f may also be made based on user input received at user device 830f. When user device 830f is within the wireless transmission ranges of multiple set-top cells, a listing of the set-top cells may be presented to a user using the illustrative display screen shown in FIG. 10. Display screen 1000 may be a display of any suitable device, but is described herein as a display of multiple set-top cells within range presented to a user on user device 830f. Display screen 1000 contains listings 1010a, 1010b, and 1010c of all set-top cells within range of user device 830f. The listings include signal strength indications 1020a, 1020b, and 1020c that indicate the strength of signals received at a user device from the set-top cells in listings 1010a, 1010b, and 1010c, respectively. Display screen 1000 may also present a location indicator, available bandwidth indicator, or any other suitable criteria to the user for each of the set-top cells in listings 1010a, 1010b, and 1010c. From the information presented on display screen 1000, the user selects a source from among the listed set-top cells for streaming media content to the user device. The user communicates the selection using a user input interface on the user device, and media content is streamed from the selected set-top cell to the user device. The non-selected set-top cells may maintain communication with and monitoring of the user device to facilitate a seamless handoff that may become necessary if the user device travels outside of the wireless transmission range of the selected set-top cell.

An illustrative example of a user device leaving the wireless transmission range of all set-top cells in a set-top cell network is described with respect to user device 830g. An authorized user device 830g may establish a connection with set-top cell 810g and may begin streaming media content. If user device 830g travels towards boundary 820d and the signal received by user device 830g from set-top cell 810g becomes weaker, either user device 830g or set-top cell 810g senses that the user device is approaching the edge of the wireless transmission range of set-top cell 810g. A determination is made that a source handoff is preferable, and the process of identifying the optimal set-top cell to receive the handoff begins. Either one of set-top cell 810g, user device 830g, or the cable provider headend supporting set-top cell 810g determines that there are no available source handoff recipient set-top cells in the direction in which user device 830g is traveling. An audible or visual warning that user device 830g is approaching the edge of the wireless transmission range of network 800a may be presented to a user on user device 830g. If user device 830g continues to travel out of the wireless transmission range of set-top cell 810g to the location of user device 830h, connection with the set-top cells of network 800a is lost and media streaming on user device 830h is interrupted. If user device 830h travels back towards boundary 820d and reenters the wireless transmission range of set-top cell 810g, a connection with set-top cell 810g is reestablished and media streaming is restarted.

Alternatively, a user device 830h that is outside of the wireless transmission range of any set-top cells may travel towards boundary 820e and enter the wireless transmission range of set-top cell 810h. Set-top cell 810h is one set-top cell in a network 800b of set-top cells that does not share any common set-top cells with network 800a. User device 830h may be authorized to receive streaming media content from the set-top cells of network 800b. In some embodiments, the set-top cells of networks 800a and 800b are all supported by the same cable provider. In some embodiments, the set-top cells of network 800a are all supported by a first cable provider, the set-top cells of network 800b are all supported by a second cable provider, and the first and second cable providers share authorized device information. In some embodiments, each of network 800a and network 800b are made up of set-top cells supported by any number of cable providers, and all of the cable providers share authorized device information. When user device 830h enters into the wireless transmission range of set-top cell 810h, set top cell 810h performs authorization verification for user device 830h. If authorization is verified, user device 830h may begin streaming media from set-top cell 810h as it travels, for example, to the location of user device 830i. User device 830i may then roam among the set-top cells of network 800b while receiving continuous streaming media content.

FIGS. 11-14 show illustrative flow diagrams for processes related to the present invention. Steps in the processes may be added, omitted, or performed in any order without departing from the scope of the invention.

FIG. 11 shows an illustrative flow diagram 1100 for registering a user device (e.g., any one of user devices 334a-e of FIG. 3) with a home set-top cell (e.g., any one of set-top cells 332a-d of FIG. 3) in accordance with the present invention.

At step 1110, a set-top cell receives a request for a connection to a user device. In some embodiments, the request for a connection is sent directly from the user device. For example, the user device may poll all set-top cells within range to obtain their locations, automatically identify the nearest set-top cell, and send a connection request to the identified set-top cell. The user device may also display all set-top cells within range and allow a user to select the set-top cell that is the user's home set-top cell. The user may also be able to send a connection request from a user device by entering a unique ID for the user's home set-top cell into an application running on the user device. In some embodiments, the request for a connection is entered by the user directly to the user's home set-top cell. For example, the user may enter a device ID for the user device using a user input interface on the set-top cell. The user may also press a button on the home set-top cell that scans the wireless transmission range for any non-registered user devices. The user may then choose the user device he or she would like to register from a list of all non-registered user devices within range of the set-top cell.

At step 1120, the set-top cell sends a registration form to the user device. The registration form sent to the user device may be the form shown in display screen 400 of FIG. 4. The information on the registration form may be substantially the same as the information discussed previously with respect to display screen 400.

At step 1130, the set-top cell receives the completed registration form from the user device for validation. The set-top cell may perform validation based on information stored in memory locally or, alternatively, may forward the completed registration form to a cable provider headend for validation (e.g., cable provider headend 310 of FIG. 3). The cable provider headend may compare information provided in the completed registration form with the records of the cable provider to verify that the user is authorized to register the user device with the set-top cell. For example, the cable provider headend may verify that the user device is a compatible device or that the user has paid a fee required for access to the set-top cell network. If there is a limit to the number of user devices that the user is allowed to register, the cable provider headend checks the number of user devices currently registered with the user's home set-top cell to verify that the maximum number of registered devices has not yet been reached. After the registration form is validated, a unique footprint profile containing information from the completed registration form and any other relevant authorization information is created for the user device.

At step 1140, the footprint profile for the registered user device is stored at the cable provider headend. The footprint profile for the registered user device may be substantially the same as the footprint profile shown in display screen 500 of FIG. 5. The cable provider headend may use the footprint profile for future authorization verification when the registered user device connects to another set-top cell in the same set-top cell network as the user's home set-top cell. The footprint profile may be stored in a database of authorized user devices that is maintained by an access control center within the cable provider headend. The access control center may continuously update the entries for registered user devices in the database as the authorization status of user devices changes. For example, if a user does not pay a bill on time, a hold is placed on the user's registered user devices. The access control center updates the authorization status for all of the user's registered user devices to indicate that the devices are temporarily blocked from accessing the set-top cell network. When the user attempts to connect to the set-top cell network, the cable provider headend will identify the hold and will block communication with the set-top cell network.

At step 1150, the footprint profile is stored on the user device. The user device stores the footprint profile in local memory to facilitate future authorization verification by set-top cells in the set-top cell network. A set-top cell may request authorization information from the user device before allowing the user device to stream media. In response to the request, the user device retrieves the footprint profile from memory and sends it to the set-top cell to be used for verification.

FIG. 12 shows an illustrative flow diagram 1200 for verifying authorization of a user device (e.g., user device 830b of FIG. 8A) to receive media content from a set-top cell (e.g., set-top cell 810b of FIG. 8A) in accordance with the present invention.

At step 1210, a set-top cell detects a user device within wireless transmission range. In some embodiments, a set-top cell may detect a user device as soon as the user device enters the wireless transmission range of the set-top cell. The set-top cell may continuously scan its wireless transmission range to identify any new user devices within range. In some embodiments, a set-top cell may detect a user device in response to receiving a request for streaming media content sent to the set-top cell by the user device. For example, a user may select the set-top cell from a list of all set-top cells within range of the user device, causing a connection request to be sent directly to the selected set-top cell. In some embodiments, a set-top cell may detect a user device in response to receiving a source handoff request sent to the set-top cell by a nearby set-top cell or by the user device.

At step 1220, information needed for authorization verification is sent from the user device to the set-top cell. In some embodiments, the user device sends a footprint profile (e.g., the footprint profile stored on the user device in step 1150 of FIG. 11) to the set-top cell. In some embodiments, the user device sends a unique identifier that is used to locate an authorization profile for the user device stored, for example, at a cable provider headend.

At step 1230, the set-top cell sends a request to a cable provider headend (e.g., cable provider headend 310 of FIG. 3) for verification of user device authorization based on the information received at step 1220. The information may be sent to a system at the cable provider headend that maintains a database of all user devices registered within the set-top cell network and continuously updates the authorization status of each user device (e.g., access control center 318 of FIG. 3). In some embodiments, the set-top cell may forward a full footprint profile with all relevant authorization information received from the user device to the cable provider headend. In some embodiments, the set-top cell may forward only a unique user device identifier and password on to the cable provider headend.

At step 1240, the cable provider headend checks the authorization of the user device and sends a notice to the set-top cell indicating the authorization status. The cable provider headend may perform the authorization check by matching the information received from the set-top cell to a profile located in an authorized user devices database at the cable headend provider (e.g., authorized device database 317). The matching profile may contain a status indicator that is continuously updated by an access control center and indicates the current authorization status of the user device. In some embodiments, a cable provider headend may match a provided full footprint profile to a full footprint protocol in a database at the cable provider headend. In some embodiments, a cable provider headend may locate a full footprint profile stored at the cable provider headend based on a provided unique identifier for the user device.

If authorization is verified, the cable provider headend sends the set-top cell an indication that the user device is authorized with the set-top cell network at step 1250. The set-top cell then allows the user device to view, navigate, and stream all media content available in the user's cable service. The set-top cell may provide the user with an audible or visual alert that the user device has been authorized for access to the set-top cell. The set-top cell may provide the user with notifications regarding the user's cable service, such as a new available software upgrade, an upcoming due payment, upcoming programming that may interest the user, or any other suitable notification.

If authorization is not verified, the cable provider headend sends the set-top cell an indication that the user device is not authorized with the set-top cell network at step 1260. The set-top cell then blocks the user device from viewing, navigating, and streaming media content from the set-top cell network. The media content that the set-top cell provides to the user device may depend on a media account with which the user device is associated. The set-top cell may provide the user with an audible or visual alert that the user device is not authorized for access to the set-top cell. The alert may include an explanation of the reason that the user device is not authorized, such as indicating that the user device has never been registered with a set-top cell, notifying the user that an outstanding bill is past due, or any other suitable explanation. An authorization problem that can be fixed by the user may be presented to the user with the option to amend the problem. For example, the user may be notified that an outstanding bill is past due and provided with a link to a website where the user can pay the bill. Once payment is complete, the user device may resend an authorization request to the set-top cell and begin the verification process again at step 1210.

FIG. 13 shows an illustrative flow diagram 1300 for accessing a set-top cell network (e.g., network 800a of FIG. 8A) from a user device (e.g., user device 830f of FIG. 8A) that is within wireless transmission range of multiple set-top cells (e.g., set-top cells 810c, 810d, and 810f of FIG. 8A) in accordance with the present invention.

At step 1310, a user device detects all set-top cells that are within wireless transmission range. The user device may analyze the signals received from the set-top cells within range to determine, for example, the strength of the signal received from each set-top cell. The user device may also poll each detected set-top cell to obtain information that may be useful in selecting one of the set-top cells to be a source for streaming media content. For example, the user device may obtain the location of each set-top cell, the bandwidth availability of each set-top cell, the demand placed on each set-top cell by all user devices to which each set-top cell is currently connected, or any other suitable information.

If the user device is configured to automatically select one of the set-top cells to be a source for streaming media content, the user device selects one of the set-top cells at step 1320. The user device may make the selection based on the information for each set-top cell obtained in step 1310. Any combination of one or more criteria information obtained in step 1310 may be used to make the selection. For example, the user device may execute an algorithm to select the set-top cell that provides the best combination of a strong signal, high bandwidth availability, and low demand currently placed on the set-top cell. The user device may be configured by the user to make the automatic selection based on a preferred combination of the criteria information. For example, if a user values signal strength more than any other factor, the user may configure the user device to always select the set-top cell that is providing the strongest signal.

If the user device is configured to allow the user to manually select one of the set-top cells to be the source for streaming media content, the user device presents the user with a list of the set-top cells within range (e.g., the listing of set-top cells shown in FIG. 10) at step 1330. In addition to presenting the names of the set-top cells to the user, the user device may also present any of the criteria information obtained in step 1310 that may assist the user in making a selection. The user's selection of the desired set-top cell to be the source for streaming media content is received at step 1340. The user may enter a selection using, for example, a user input interface on the user device (e.g., user input interface 240 in FIG. 2).

At step 1350, the user device sends a connection request to the selected set-top cell. The connection request initiates an authorization verification of the user device. The verification process may be, for example, the process described with respect to illustrative flow chart 1200 of FIG. 12. Sending a connection request to the selected set-top cell may include sending a unique identifier for the user device or a full footprint profile stored on the user device with the connection request.

If the user device authorization is verified, the user may begin viewing, navigating, and streaming all media content available through the selected set-top cell at step 1360. The user device may present an alert or notification to the user as previously discussed with respect to step 1250 of FIG. 12.

If the user device authorization is not verified, the user device is blocked from viewing, navigating, and streaming media content available through the selected set-top cell at step 1370. The user device may provide the user with an alert or notification as previously discussed with respect to step 1260 of FIG. 12.

FIG. 14 shows an illustrative flow diagram 1400 for executing a streaming media content source handoff in a set-top cell network (e.g., network 800a of FIG. 8A) in accordance with the present invention.

The source handoff process in a set-top cell network is performed dynamically in order to provide users with seamless, uninterrupted media content. Since the movement of user devices is unpredictable, the set-top cell network must be able to continuously monitor and respond to the constant location changes of user devices within the network. An effective source handoff is executed by actively identifying a user device that is at risk of losing a set-top cell connection and identifying a set-top cell to receive the handoff prior to the user device losing connection with its current source set-top cell. This proactive approach may be carried out by any component of the set-top cell network that is capable of obtaining information about the user devices and the set-top cells.

In some embodiments, a cable provider headend (e.g., cable provider headend 310 of FIG. 3) may govern source handoffs. The cable provider headend is in communication with all set-top cells of the set-top cell network, and thus can constantly poll and obtain information from all set-top cells and user devices detected by the set-top cells in the network. With this information, the cable provider headend may continuously determine the optimal arrangement of connections of user devices to set-top cells and may facilitate selection of set-top cells to be the recipients of source handoffs for problematic user devices. The cable provider headend may also be able to identify problematic user devices that are headed out of the wireless transmission range of their current set-top cell source or out of the wireless transmission range of the whole set-top cell network.

In some embodiments, a set-top cell in a set-top cell network (e.g., set-top cell 810a of FIG. 8A) may govern source handoffs. Since the locations of set-top cells may not change often, a set-top cell may store information about nearby set-top cells that may be useful in executing a source handoff. A set-top cell streaming media to a user device may detect that a source handoff is preferable for the user device. Based on information received from the user device, the set-top cell may use locally stored information about nearby set-top cells to identify potential recipient set-top cells for the source handoff. The information may then be used to select one of the potential set-top cells as the optimal recipient for the source handoff. A set-top cell may continuously monitor user devices in range and communicate to inform nearby set-top cells the media content that is being sent to media devices. The nearby set-top cells may then ensure that the media content is available in case they are chosen as the recipient of a source handoff for the user device.

The set-top cells in a network may govern source handoffs by using a load balancing mechanism. In some embodiments, the set-top cells in a network may be configured with a demand load threshold for the demand placed on a set-top cell by all user devices connected to the set-top cell. When a set-top cell is connected to multiple user devices, the demand placed on the set-top cell by the user devices may reach the demand load threshold. If the set-top cell detects that the threshold has been reached, the set-top cell initiates a source handoff for at least one of the connected user devices. The set-top cell may initiate source handoffs until the demand placed on the set-top cell drops below the demand load threshold. The set-top cell may also continue to initiate source handoffs until the demand placed on the set-top cell by the connected user devices is spread evenly over neighboring set-top cells within range of the user devices.

In some embodiments, a user device within a set-top cell network (e.g., user device 830a of FIG. 8A) may govern source handoffs. At any time, a user device can identify the set-top cells within range and obtain information about the set-top cells either by requesting information from the set-top cells or by analyzing the signals received from the set-top cells. This approach allows a user device anywhere in the set-top cell network to identify the need for and execute source handoffs without control from the set-top cells or cable provider headend. When the need for a source handoff is detected, a user device may initiate the handoff by sending a request to a handoff recipient set-top cell for the media content and resources currently being accessed by the user device. Source handoffs governed by user devices do not require the large amounts of stored data, such as set-top cell locations, set-top cells nearby each individual set-top cell, usual source handoff recipients for each individual set-top cell, or any other suitable data, required by source handoffs governed by cable provider headends or set-top cells. Thus, source handoffs governed by user devices may improve performance by allowing the cable provider headend and set-top cells to store a minimal amount of data.

The steps shown in illustrative flow diagram 1400 may be performed by any suitable component of a set-top cell network, such as a cable provider headend (e.g., cable provider headend 310 of FIG. 3), set-top cell (e.g., set-top cell 810 a of FIG. 8A), user device (e.g., user device 830a of FIG. 8A), or any other suitable device. For the purpose of illustration and not limitation, the source handoff process is described herein with respect to a source handoff governed by a set-top cell.

A set-top cell provides media content to an authorized user device within its wireless transmission range. At step 1410, the set-top cell determines that a source handoff to another set-top cell is preferable. In some embodiments, the set-top cell may continuously poll the user device to obtain and monitor the location of the user device. The monitored location of the user device may indicate that the user device is moving away from the set-top cell and is approaching other set-top cells, that the user device is entering a region between a minimum wireless transmission range and a maximum wireless transmission range of the set-top cell, or that the user device is approaching the edge of the wireless transmission range of the set-top cell. In some embodiments, the set-top cell may sense that the strength of the signal received by the user device from the set-top cell is becoming weak. In some embodiments, the set-top cell may be overloaded by multiple user devices streaming media content and may look to execute a source handoff to a set-top cell streaming media content to fewer user devices. In some embodiments, the set-top cell may be connected to multiple user devices and may be configured with a demand load threshold. The set-top cell may determine the need for source handoffs by detecting an overload when the demand placed on the set-top cell reaches the demand load threshold. Additionally, the set-top cell may determine that a source handoff is preferable based on any combination of these criteria or any other suitable criteria.

At step 1420, the set-top cell identifies nearby set-top cells as potential recipients of the source handoff. In some embodiments, the set-top cell may identify potential recipients based on the locations of nearby set-top cells. For example, the set-top cell may store a list of neighboring set-top cells with location information obtained by periodically polling nearby set-top cells. In some embodiments, the set-top cell may poll the user device to identify all other set-top cells currently within range of the user device as potential recipients. Additionally, the set-top cell may identify potential recipients based on any combination of these criteria or any other suitable criteria.

At step 1430, the set-top cell selects the optimal recipient of the source handoff from among the potential recipients identified in step 1420. In some embodiments, the set-top cell may select the optimal recipient based on the direction of travel of the user device indicated, for example, by a location sensor on the user device (e.g., location sensor 250 of FIG. 2). After determining the direction of travel of the user device, the set-top cell obtains the locations of the potential recipients from local memory or by polling the potential recipients for locations indicated, for example, by a location sensor on each set-top cell (e.g., location sensor 150 of FIG. 1). The set-top cell then determines which potential recipient the user device is traveling toward and selects that set-top cell as the optimal recipient. In some embodiments, the set-top cell may select the optimal recipient based on the strength of signals received by the user device from the potential recipient set-top cells. The set-top cell polls the user device to determine the strength of signals received by the user device from each potential recipient and selects the potential recipient with the strongest signal as the optimal recipient. In some embodiments, the set-top cell may select an optimal recipient based on the demand placed on the potential recipient set-top cells by all user devices to which they are currently connected. The set-top cell polls potential recipients to determine the load placed on each potential recipients by all user devices to which they are currently connected and selects the set-top cell with the lowest load as the optimal recipient. Additionally, the set-top cell may select an optimal recipient based on any combination of these criteria or any other suitable criteria.

At step 1440, the set-top cell determines whether or not the selected recipient set-top cell for the source handoff has verified the authorization of the user device. Authorization verification may have been performed by the selected set-top cell, for example, as soon as the user device entered into wireless transmission range. If authorization has already been verified, the new set-top cell begins streaming media to the user device at step 1460. If authorization has not already been verified, the new set-top cell performs authorization verification at step 1450. The verification performed at step 1450 may correspond, for example, to the verification process discussed with respect to illustrative flow diagram 1200 of FIG. 12. In some embodiments, the current source set-top cell may send an indication that the user device is authorized directly to the new set-top cell. Once authorization is verified, the new set-top cell begins streaming media to the user device at step 1460. At step 1460, the seamless handoff is complete, and the user may leave the wireless transmission range of the original source set-top cell without experiencing an interruption of the streaming media content service.

The foregoing is merely illustrative of the principles of this invention, and various modifications can be made by those skilled in the art without departing from the scope and spirit of the invention.

1. A method for presenting media content on a user device from a network of set-top cells, the method comprising:
sending media content to a user device from a first set-top cell, wherein the first set-top cell is associated with a media account of a first user;
detecting the need for a source handoff from the first set-top cell to a second set-top cell, wherein the second set-top cell is associated with a media account of a second user;
sending a request from the first set-top cell to the second set-top cell to initiate the source handoff; and
handing off the source of media content sent to the user device from the first set-top cell to the second set-top cell.

2. The method of claim 1, wherein the request includes authorization for the user device to receive media content from the second set-top cell.

3. The method of claim 1, wherein the detecting comprises detecting the need for a source handoff based on a signal received by the user device from the first set-top cell.

4. The method of claim 1, further comprising:
storing information associated with set-top cells nearby the first set-top cell in memory on the first set-top cell; and
selecting the second set-top cell based on the information stored in memory on the first set-top cell.

5. The method of claim 4, wherein the information stored in memory on the first set-top cell includes locations of the set-top cells nearby the first set-top cell.

6. The method of claim 5, further comprising selecting the second set-top cell based on a direction of travel of the user device.

7. The method of claim 1, further comprising selecting the second set-top cell based on a signal received from the second set-top cell by the user device.

8. The method of claim 1, wherein the detecting comprises detecting the need for a source handoff based on a location of the user device.

9. The method of claim 8, wherein:
the first set-top cell is associated with a minimum wireless transmission range and a maximum wireless transmission range; and
the detecting comprises detecting that the user device is located between the minimum and maximum wireless transmission ranges.

10. A set-top cell for presenting media content on a user device from a network of set-top cells, the set-top cell comprising:
circuitry that is configured to:
send media content to a user device, wherein the set-top cell is associated with a media account of a first user;
detect the need for a source handoff to a second set-top cell, wherein the second set-top cell is associated with a media account of a second user;
send a request to the second set-top cell to initiate the source handoff; and
hand off the source of media content sent to the user device to the second set-top cell.

11. The set-top cell of claim 10, wherein the request includes authorization for the user device to receive media content from the second set-top cell.

12. The set-top cell of claim 10, wherein the circuitry is configured to detect the need for a source handoff based on a signal received by the user device from the circuitry.

13. The set-top cell of claim 10, further comprising memory configured to store information associated with nearby set-top cells, wherein the circuitry is further configured to select the second set-top cell based on the information stored in the memory.

14. The set-top cell of claim 13, wherein the information stored in the memory includes locations of the nearby set-top cells.

15. The set-top cell of claim 14, wherein the circuitry is configured to select the second set-top cell based on a direction of travel of the user device.

16. The set-top cell of claim 10, wherein the circuitry is configured to select the second set-top cell based on a signal received from the second set-top cell by the user device.

17. The set-top cell of claim 10, wherein the circuitry is configured to detect the need for a source handoff based on a location of the user device.

18. The set-top cell of claim 10, wherein:
the set-top cell is associated with a minimum wireless transmission range and a maximum wireless transmission range; and
the circuitry is configured to detect that the user device is located between the minimum and maximum wireless transmission ranges.

19-27. (canceled)
